(19) United States
(12) Patent Application Publication
(10) Pub. No.: US 2005/0067517 A1
(43) Pub. Date: Mar. 31, 2005

(54) Gravity impeller apparatus for centrifugal rock crusher turntable

(76) Inventor: Brett M. Rose, Vancouver, WA (US)

Correspondence Address: OLSON AND OLSON, 5412 SE FOSTER ROAD, PORTLAND, OR, 97206, US

(21) Appl. No.: 10/949,272

(22) Filed: Sep. 23, 2004

Related U.S. Application Data
(60) Provisional application No. 60/506,248, filed on Sep. 25, 2003.

(51) Int. Cl. B02C 19/00

(52) U.S. Cl. 241/275

(57) ABSTRACT

The impeller assembly of a centrifugal rock crusher is secured removably to a dovetail coupling member secured to a mounting member attached to the turntable of a centrifugal rock crusher. The impeller member has a mating dovetail shape cavity on its face trailing the direction of rotation of the turntable and configured to match the dovetail configuration of the coupling member. The dovetail configurations are arranged to tilt upwardly and radially inward relative to the rotational direction of the turntable, whereby turntable rotation produces centrifugal force driving the impeller member downward and inward relative to turntable rotation, to induce downward and inward movement of the impeller member relative to the coupling member, to increase securement.

This application claims the benefit of Provisional application Ser. No. 60/506,248, filed 25 Sep. 2003.

### BACKGROUND OF THE INVENTION

This invention relates to rock crushers, and more particularly to a novel impeller system for centrifugal rock crushers.

Centrifugal rock crushers of the prior art are large pieces of equipment basically comprising a hollow, fixed drum having a rotatable turntable disposed centrally within the drum and driven by a motor at predetermined rotary speed. The rotatable turntable mounts a plurality of impeller units of selected hardened metal in a manner to engage rock and flinging it at high speed outwardly into impact against circumferentially arranged anvil members. The resulting shattered rock fragments fall by gravity to the base of the drum from whence they are conveyed outwardly for collection and subsequent use. It will be recognized that the tremendous forces encountered in the process results in wear and breakage primarily of the impeller units, requiring their periodic repair or replacement.

However, the impeller structures of prior art centrifugal rock crusher turntables require the manipulation of a plurality of bolts and other types of releasable attachments, incurring excessive down time and extensive and costly disassembly and reassembly costs.

### SUMMARY OF THE INVENTION

The rock crusher of this invention provides for a normal, substantially tool free replacement of the impeller components of the turntable assembly for quick routine replacement operations and also provides an impeller mounting structure which is protected against wear and damage during operation of the rock crusher.

It is the principal objective of this invention to provide an impeller system for centrifugal rock crusher turntables that overcomes the disadvantages and limitations of prior rock crushers.

Another objective of this invention is the provision of an impeller system for centrifugal rock crusher turntables that facilitates rapid replacement, thereby minimizing the operational down time.

Still another objective of this invention is to provide an impeller assembly for centrifugal rock crusher turntables in which the components of the impeller assembly are capable of rapid assembly and disassembly, substantially without tools.

A further objective of this invention is the provision of an impeller system for centrifugal rock crusher turntables in which the components of the assembly are interconnected by dovetail connections.

A still further objective of this invention is to provide an impeller assembly for centrifugal rock crushers in which the interconnecting elements of the components are contained internally and thus protected against damage and wear.

The foregoing and other objects and advantages of this invention will appear from the following detailed description, taken in connection with the accompanying drawings of a preferred embodiment.

### BRIEF DESCRIPTION OF THE DRAWINGS

FIG. 1 is a fragmentary perspective view of a centrifugal rock crusher of the prior art, portions being broken away to disclose internal structural details.

FIG. 2 is a perspective view of a turntable having mounted thereon an impeller system embodying the features of this invention.

FIG. 3 is a fragmentary perspective view of the turntable of FIG. 2 with an impeller assembly shown in exploded view to illustrate the manner of assembly and disassembly of the components thereof.

FIG. 4 is a fragmentary perspective view, similar to FIG. 3, showing the impeller assembly components in exploded view from the opposite side of the mounting block component of FIG. 3.

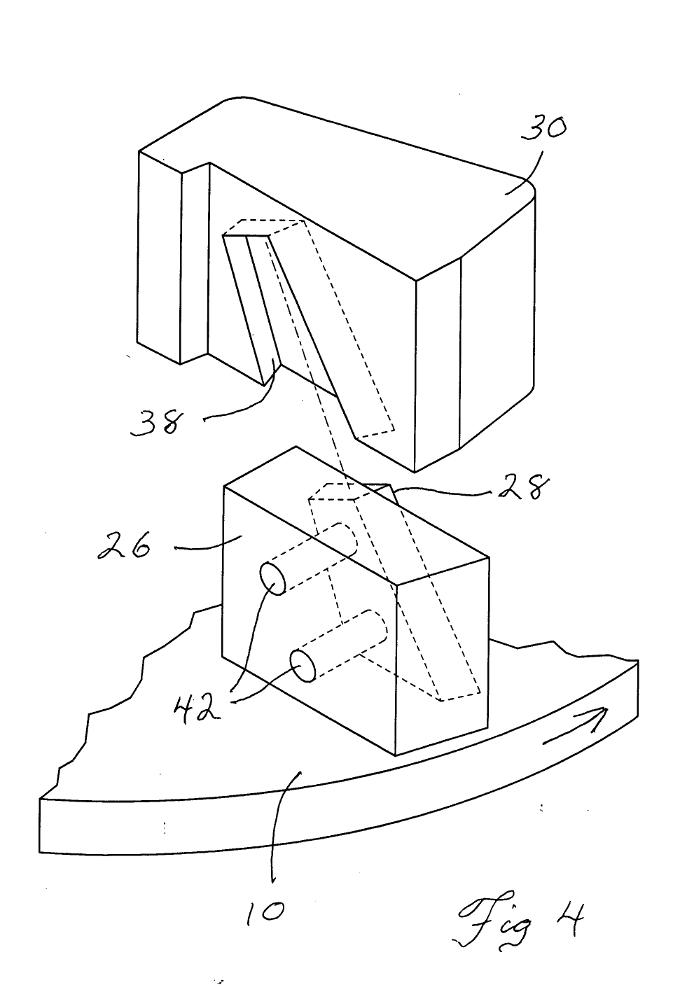

### DESCRIPTION OF THE PREFERRED EMBODIMENT

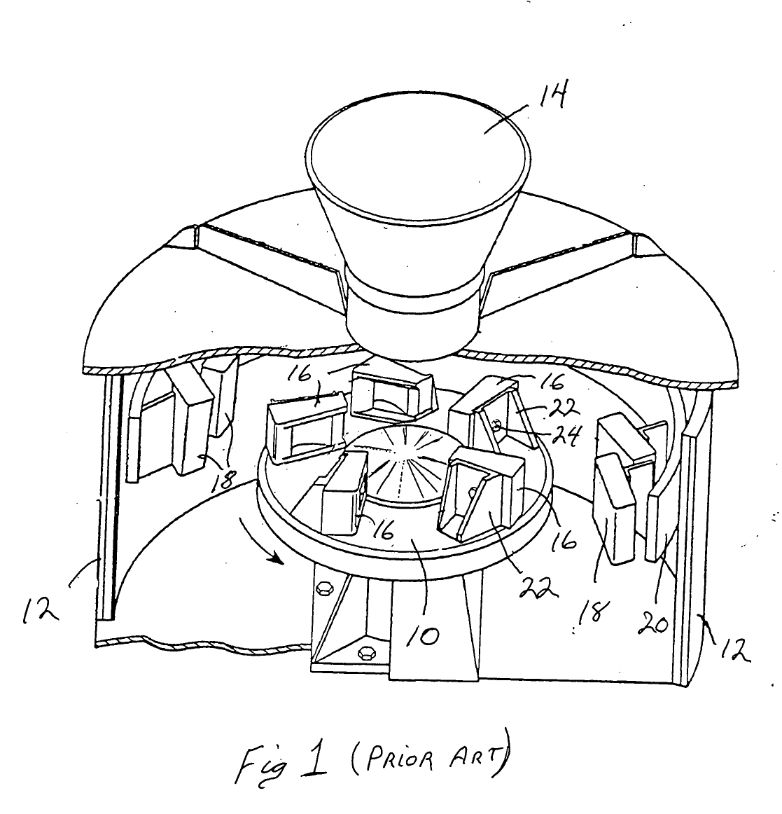

Referring first to the prior art structure of FIG. 1, a turntable 10 is mounted for rotation within a housing 12 provided with an infeed funnel 14 through which rock to be crushed is delivered to the central portion of the turntable. Rotation of the turntable causes the rock to be moved radially outward into engagement with circumferentially spaced impeller units 16 which thereupon thrust the rock at high velocity radially outward of the rapidly rotating turntable into impact with anvil members 18 supported circumferentially a spaced distance radially outward from the turntable on a ring 20 secured within the housing. The resulting crushed rock is discharged through an outlet in the bottom of the housing for collection and use.

It is to be noted in the prior art structure of FIG. 1 that the impeller units are secured to the turntable by means of brackets 22 secured to the turntable and screws or bolts 24 are employed to secure the impeller units 16 to the bracket.

In the present invention the impeller units each comprises a mounting block 26, a coupling block 28 and an impeller member 30. The mounting block 26 is secured to the turntable 10 as by welding, by bolts extending upwardly through openings in the turntable and into registering threaded bores in the mounting block, or by other means as desired. The face of the mounting block 26 facing the direction of rotation of the turntable mounts the coupling block 28, configured as a wedge, with sides 32 and 34 tapering from the bottom end to smaller dimension at the top end 36. The sides 32 and 34 also taper inwardly from their leading face to the trailing face. The sides 32 and 34 thus form a dovetail configuration which matches and mates with the complimentary dovetail socket 38 in the trailing face of the impeller member 30. Thus, the impeller system is installed in secure position on the turntable 10 simply by sliding the dovetail socket 38 in the impeller member downward onto the dovetail coupling block 28.

Moreover, the dovetail coupling block 28 and complimentary dovetail socket 38 on the impeller member 30 are positioned angularly with respect to vertical such that rotation of the turntable creates centrifugal force that drives the impeller member 30 radially outward and downward toward the upper surface of the turntable 10. This movement results in correspondingly increasing positive coupling of the dovetail coupling block 28 and socket 38.

Removal of the impeller member 30, for replacement or repair, is achieved without tools, but rather only with the hands, to disconnect the dovetail connection, thereby simplifying and expediting the replacement or repair procedure.

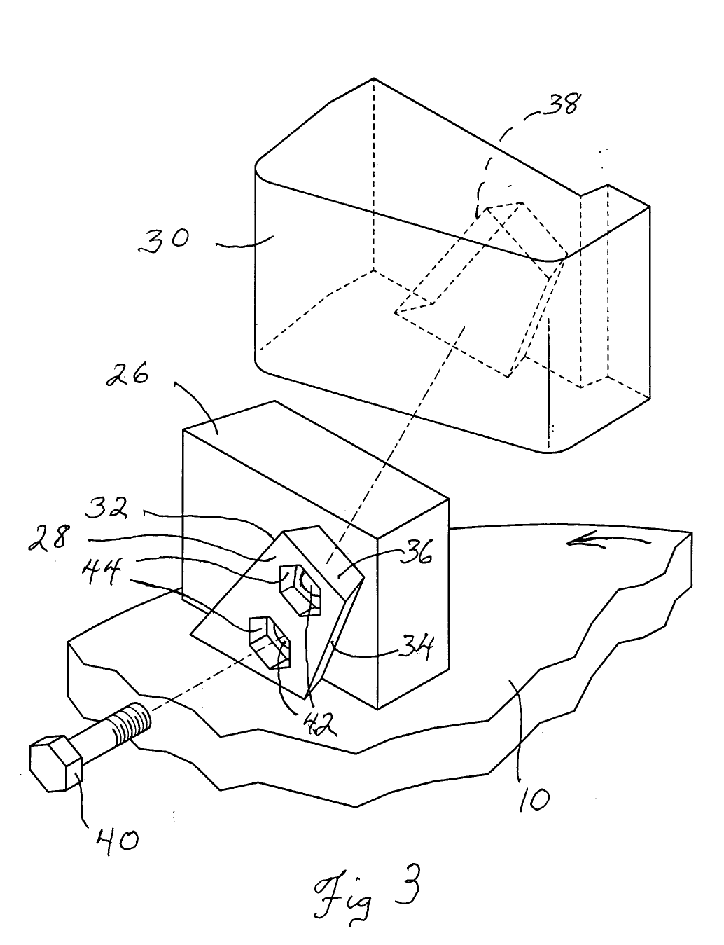

The dovetail coupling block 28 is secured to the mounting block by bolts 40 extended through the unthreaded openings 42 in the dovetail coupling block and then into threaded openings in the mounting block 26. If desired, the bolts 40 alternatively may be extended through unthreaded openings in the mounting block 26 and then into threaded openings 42 in the coupling block 28. The arrangement illustrated in FIG. 3 is preferred, however, because the coupling block 28 and mounting bolts 40 are contained within the interior of the impeller member 30 and thereby protected from damage.

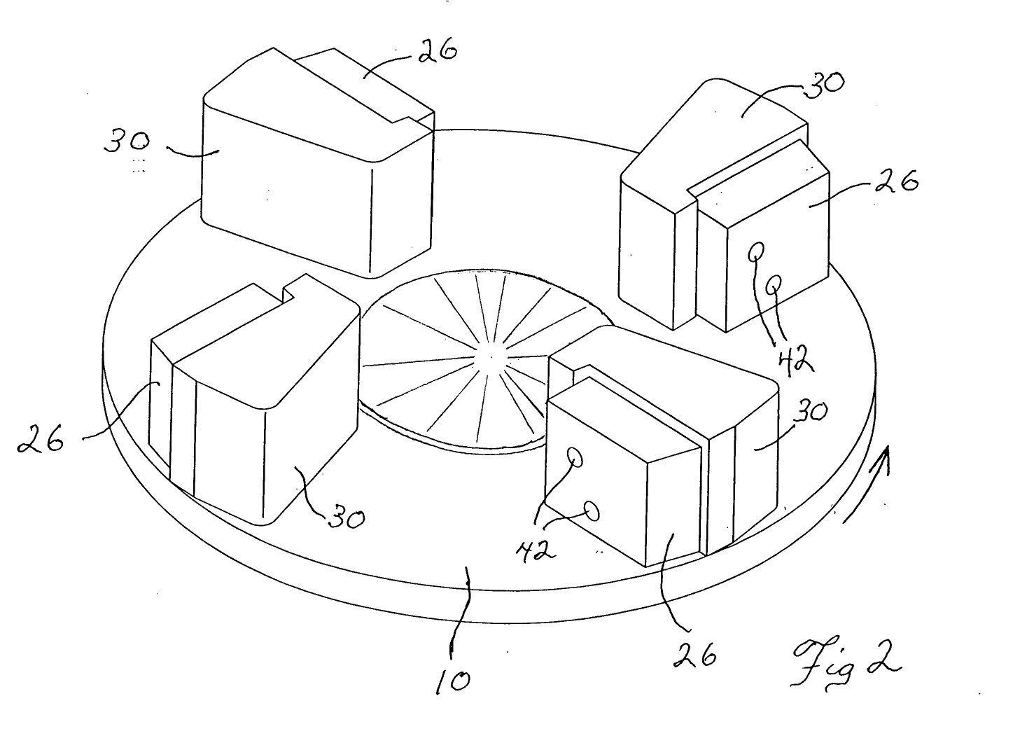

It is to be noted that FIG. 1 shows the prior art turntable 10 as mounting five impeller units 16, whereas FIG. 2 shows the mounting of four impeller assemblies. The number of impeller assemblies for a chosen turntable may be varied, as desired for any particular rock crusher use.

It will be apparent to those skilled in the art that various changes and modifications, other than those previously described, may be made in the size, shape, type, number and arrangement of parts described herein. For example, a wear ring may be configured to overlie and be secured to the impeller units to direct infeed rocks radially outward for engagement by the impellers which then fling the rocks outward at high speed into impact against the anvils 18. These wear ring structures are well known in the art and therefore need not be described in further detail here.

The bolts 40 shown in FIG. 3 may be arranged to extend in the reverse direction through slightly enlarged, non-threaded bores through the mounting block 26 for engagement each with a threaded nut (not shown) captured in a hexagonal recess 44 (illustrated) provided in the coupling member 28. Thus, with the coupling member engaging impeller member 30 through the nut and bolt arrangement in a substantially loosened condition, the impeller member 30 may be installed on the loose coupling member 28 after which the bolts 40 are tightened, frictionally clamping the impeller member 30 and coupling member 28 rigidly on the mounting block member 26. This arrangement allows the impeller member 30 to be seated lower on the turntable 10 in frictionally clamped condition. The foregoing and other changes may be made without departing from the spirit of this invention, or the scope of the appended claims.

1. An impeller assembly for mounting on a rotary turntable of a centrifugal rock crusher, comprising:
a) a mounting member arranged to be secured to a turntable of a centrifugal rock crusher and having one face facing the direction of turntable rotation,
b) an impeller block member having leading and trailing faces, and
c) mutual coupling means on the leading face of the mounting member and the trailing face of the impeller block configured for mutual abutting interengagement by relative movement of the leading face of one of said members and the trailing face of the other of said members.

2. The impeller assembly of claim 1 wherein the mutual coupling means comprises interengaging connector members one on the leading face of said mounting member and the other on the trailing face of said impeller block member.

3. The impeller assembly of claim 1 wherein the mutual coupling means comprises interengaging dovetail connector members one on the leading face of said mounting member and the other on the trailing face of said impeller block member.

4. The impeller assembly of claim 1 wherein the mutual coupling means comprises interengaging dovetail members configured for releasable interengagement by relative movement in a substantially vertical plane.

5. The impeller assembly of claim 4 wherein the dovetail members are configured for engagement upon relative movement in a downward direction and for disengagement upon relative movement in an upward direction.

6. The impeller assembly of claim 4 wherein the dovetail members are disposed on said mounting and impeller block members for relative engaging and disengaging movements in a direction at an angle relative to vertical.

7. The impeller assembly of claim 4 wherein the dovetail members are movable in the downward direction for interengagement and are movable in the upward direction for disengagement.

8. An impeller assembly for mounting on a rotary turntable of a centrifugal rock crusher, comprising:
a) a mounting member having opposed faces and arranged to be secured to a turntable with one face of the block facing the direction of turntable rotation,
b) a coupling block member secured to said one face of the mounting member, the coupling block member having opposed longitudinal sides tapered upwardly to smaller dimension and tapered inwardly to smaller dimensions from its leading face to its trailing face abutting the leading face of the mounting member, the coupling block thereby forming a dovetail configuration, and
c) an impeller block member having leading and trailing faces, a socket member formed in the trailing face of said impeller block member and configured to match the dovetail configuration of said coupling block member for mutual releasably interconnection.

9. The impeller assembly of claim 8 wherein the coupling block member is secured to the mounting member with the longitudinal dimension extending angularly upward and radially inward relative to the turntable rotation, whereby centrifugal force moves the impeller member increasingly downward to increased securement to the coupling block member.
